(19) United States
(12) Patent Application Publication
(10) Pub. No.: US 2005/0241423 A1
(43) Pub. Date: Nov. 3, 2005

(54) Inertia brake controls

(76) Inventors: Ronald Peter Muetzel, Friedrichshafen (DE); Karl-Fritz Heinzelmann, Meckenbeuren (DE); Charles E. Allen JR., Rochester Hills, MI (US); Winfried Sturmer, Euerbach (DE); Ludger Ronge, Eriskirch (DE); Loren Christopher Dreier, Vass, NC (US); Robert Anthony Sayman, Laurinburg, NC (US); James Henry DeVore, Laurinburg, NC (US); Muneer AbuSamra, Southern Pines, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/833,732

(22) Filed: Apr. 28, 2004

(51) Int. Cl. F16H 3/08

(52) U.S. Cl. 74/325

(57) ABSTRACT

An inertia brake assembly for a transmission includes a hollow shaft rotatable relative to an input shaft of the transmission. An inertia brake housing is rotatable relative to the input shaft and the hollow shaft. A first clutch assembly couples the hollow shaft to the inertia brake housing. A second clutch assembly couples the input shaft to the inertia brake housing and a retarder assembly couples the inertia brake housing to the transmission housing. Selective actuation of a combination of the various clutch assemblies provides the functions of an inertia brake, engine brake, hill holder, master clutch and drive a power take-off assembly.

### BACKGROUND OF THE INVENTION

This invention relates generally to a transmission assembly, and specifically to a transmission assembly that includes an integrated inertia brake assembly.

Conventional automated manual transmissions utilize actuators to shift between gear ratios according to a predefined algorithm. Rollback of a vehicle equipped with an automated manual transmission can occur within the time an operator releases the brake pedal and engages a throttle pedal. The rollback of the vehicle during this time period is undesirable.

It is known to provide an inertia brake for controlling counter-shaft speed during gear changes within a transmission. It is also known to use the inertia brake disposed on the transmission countershaft as a hill holding device that is actuated to prevent vehicle rollback. The inertia brake includes a clutch assembly that is installed on a countershaft of the transmission. When the transmission is decoupled from the engine, the inertia brake is engaged to prevent rotation of the transmission output shaft, and thereby undesirable movement of the vehicle. The inertia brake assembly includes a plurality of pressure plates that are grounded to the transmission housing. The pressure plates can move axially relative to the transmission to engage a corresponding plurality of friction plates that are rotated with the countershaft. Engagement of the clutch assembly slows or stops the countershaft and thereby the transmission output shaft to prevent undesirable movement of the vehicle.

Further, it is also known to provide an engine brake to control the rotational speed of the engine in unison with gears within the transmission to facilitate shifting between desired gear ratios.

Disadvantageously, known inertia, and engine brakes provide only limited functions and are not easily adaptable to most transmissions. Further, in many instances inertia brake assemblies prevent the use or installation of a power take off assembly.

Accordingly, it is desirable to design a device that provides the functions of hill holder, inertia brake, engine brake, power take off and countershaft synchronization that is adaptable and cost effective.

### SUMMARY OF THE INVENTION

A transmission assembly according to this invention includes an inertia brake assembly that provides the functions of a hill holder, inertia brake, and engine brake, power take off and countershaft synchronization device.

The inertia brake assembly is assembled within the transmission between the master clutch assembly and the selectable gears within the transmission. The inertia brake assembly includes a hollow shaft mountable to rotate with the flywheel. The master clutch assembly is disposed within the hollow shaft assembly adjacent the flywheel to provide for coupling of the input shaft to the driven flywheel. Adjacent an end of the hollow shaft is an inertia brake housing. The inertia brake housing is rotatable about the axis independent of the hollow shaft or the input shaft. The inertia brake housing includes a retarder assembly that inhibits movement of the inertia brake housing.

A first clutch assembly is disposed between the inertia brake housing and the hollow shaft for coupling the hollow shaft to the inertia brake housing. A second clutch assembly is disposed between the input shaft and an inner diameter of the inertia brake housing. The second clutch assembly couples the input shaft to the inertia brake housing.

The inertia housing includes an outer surface with gears that drive an auxiliary gear. The auxiliary gear in turn drives a power take-off assembly. The power take-off assembly includes a power take off clutch assembly that couples a power take-off shaft to the auxiliary gear. The power take-off clutch assembly includes a hollow shaft that is driven about the power take off shaft. The hollow shaft rotates whenever the inertia brake housing is rotated. The power take-off clutch assembly is disposed within an annular space between the power take-off shaft and the hollow shaft and couples the hollow shaft and the take-off shaft to drive the take-off shaft.

Accordingly, the inertia brake assembly of this invention provides a single device that provides an adaptable and cost effective device that can function as holder, inertia brake, engine brake, power take off and countershaft synchronization device.

The various features and advantages of this invention will become apparent to those skilled in the art from the following detailed description of the currently preferred embodiment. The drawings that accompany the detailed description are briefly described below.

### BRIEF DESCRIPTION OF THE DRAWINGS

FIG. 1 is a schematic cross-section of a transmission including an inertia brake assembly according to this invention.

FIG. 2 is a schematic cross-section of another inertia brake device according to this invention.

### DETAILED DESCRIPTION OF THE PREFERRED EMBODIMENT

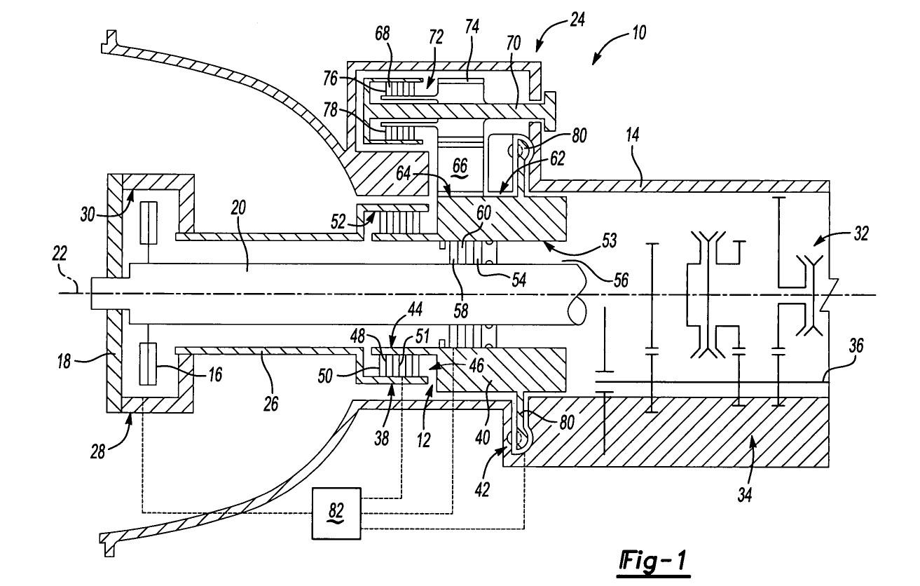

Referring to FIG. 1, a transmission 10 including an inertia brake assembly 12 is disclosed. The transmission 10 includes a housing 14 fixed relative to rotation of a master clutch assembly 16 that is driven by a flywheel 18. The master clutch assembly 16 couples the flywheel 18 to an input shaft 20 rotatable about an axis 22. The inertia brake assembly 12 is assembled within the transmission 10 between the master clutch assembly 16 and the selectable gears within the transmission 10. The input shaft 20 extends through the center of the inertia brake assembly 12. The inertia brake assembly 12 provides several functions such as engine brake, hill holding brake, inertia brake and drives a power take-off assembly 24.

The inertia brake assembly 12 includes a hollow shaft 26 mounted to rotate with the flywheel 18. The hollow shaft 26 rotates concentrically about the input shaft 20 and includes a first end 28 having an inner diameter 30 that is larger than the master clutch assembly 16. The master clutch assembly 16 is disposed within the hollow shaft 26 adjacent the flywheel 18 for coupling the input shaft 20 to the flywheel 18. The input shaft 20 extends through the inertia brake assembly 12 and drives gears 32 (shown schematically) that are combinable with gears 34 disposed on a countershaft 36 to provide a desired gear ratio.

The input shaft 20 extends through the hollow shaft 26 and through the inertia brake assembly 12. Adjacent a second end 38 of the hollow shaft 26 is an inertia brake housing 40. The inertia brake housing 40 is rotatable about the axis 22 independent of the hollow shaft 26 and the input shaft 20. The inertia brake housing 40 includes a retarder assembly 42 that inhibits movement of the inertia brake housing 40.

The hollow shaft 26 receives a portion 44 of the inertia brake housing 40. An annular space 46 is formed between an inner surface 52 of the hollow shaft 26 and the portion 44 received within the hollow shaft 26. A first clutch assembly 48 is disposed within the annular space 46 for coupling the hollow shaft 26 to the inertia brake housing 40. Preferably the first clutch assembly 48 includes a plurality of pressure plates 50 mounted to the inner surface 52 of the hollow shaft 26 and a corresponding plurality of friction plates 51 mounted for rotation with the inertia brake housing 40.

The input shaft 20 extends through the inertia brake housing 40 and a second clutch assembly 54 is disposed in an annular space 56 between the input shaft 20 and the inner surface 53 of the inertia brake housing 40. The second clutch assembly 54 couples the input shaft 20 to the inertia brake housing 40. The second clutch assembly 54 includes a plurality of pressure plates 58 mounted on the inner surface 53 of the inertia brake housing 40, and a corresponding plurality of friction plates 60 mounted on the input shaft 20.

The inertia brake housing 40 includes an outer surface 62 with gear teeth 64 that drive an auxiliary gear 66. The auxiliary gear 66 in turn drives power take-off assembly 24. The power take-off assembly 24 includes a power take off clutch assembly 68 that couples a power take-off shaft 70 to the auxiliary gear 66.

The power take-off clutch assembly 68 includes a rotating housing 74 that is driven about the power take off shaft 70. The rotating housing 74 rotates whenever the inertia brake housing 40 is rotated. The power take-off clutch assembly 68 is disposed within an annular space 72 between the power take-off shaft 70 and the rotating housing 74. The power take-off clutch assembly 68 couples the rotating housing 74 and the take-off shaft 70 to drive the take-off shaft 70. The power take-off clutch assembly 68 is disposed within the annular space 72 and includes a plurality of pressure plates 76 and a corresponding plurality of friction plates 78.

The retarder assembly 42 engages the inertia brake housing 40 and prevents or slows rotation of the inertia brake housing 40. The retarder assembly 42 grounds the inertia brake housing 40 to the housing 14, that in turn prevents or reduces rotation of the inertia brake housing 40. The retarder assembly 42 is disposed on a flange member 80 of the inertia brake housing 40. The retarder assembly 42 provides sufficient braking force to prevent rotation of the inertia brake housing 40. Further, the amount of braking force exerted by the retarder assembly 42 can be proportionally applied to slow the inertia brake housing 40 to a desired rotational speed.

As appreciated, actuation of the master clutch assembly 16, first clutch assembly 48, second clutch assembly 54, retarder assembly 42 and power take-off clutch assembly 68 provides various beneficial and desirable operating functions. During operation a controller 82 selectively actuates specific clutch assemblies to provide the desire function. The inertia brake assembly 12 can be actuated to provide the master clutch function, transmission input shaft inertia brake, hill holder, engine brake, and selectively drive the power take-off. Further, several of these functions can be obtained combining the actuation of several different clutch assemblies.

The master clutch function is typically provided by actuation of the master clutch assembly 16 as is known. During actuation of the master clutch assembly 16 to drive the vehicle, the inertia brake assembly 12 is not activated. Meaning that neither the first or second clutch assemblies 48, 54 is actuated to couple the hollow shaft 26 or the inertia brake housing 40. As is typical during operation, actuation of the master clutch assembly 16 couples the input shaft 20 to the flywheel 18 to drive the transmission 10.

The inertia brake assembly 12 of this invention can provide the master clutch function by activating the first and second clutch assemblies 48,54 such that torque is transmitted through the hollow shaft 26 and inertia brake housing 40 to the input shaft 20. Actuation of the first and second clutch assemblies 48,54 provides essentially a back-up master clutch assembly. Not only can the first and second clutch assemblies 48,54 be actuated as a substitute for the master clutch assembly 16, the master clutch assembly 16, along with the first and second clutch assemblies 48,54 can be actuated to transmit torque from the flywheel 18 to the input shaft 20.

The inertia brake assembly 12 provides a hill holding capability by actuating the retarder assembly 42, and second clutch assembly 54 to ground the inertia brake housing 40 and to couple the input shaft 20 to the inertia brake housing 40. The master clutch assembly 16, and the first clutch assembly 48 are left open so as not to transmit torque to the input shaft 20. The retarder assembly 42 includes sufficient braking force to hold the vehicle during start up of the vehicle on an incline. Actuation of the second clutch assembly 54 couples the input shaft 20 to the inertia brake housing 40, and the retarder assembly 42 grounds the inertia brake housing 40 to the housing 14.

The inertia brake assembly 12 also provides the function of an engine brake and inertia brake for the input shaft 20 to control counter-shaft speed during shifting. The inertia brake assembly 12 provides an engine brake function by actuating the first clutch assembly 48 and the retarder assembly 42. Actuating the first clutch assembly 48 and the retarder assembly 42 grounds the hollow shaft 26, and thereby the flywheel 18 to the housing 14. By proportionally actuating the retarder assembly 42 or the first clutch assembly 48, the rotational speed of the flywheel 18 is controlled to provide proper synchronization between the gears 32,34 within the transmission 10.

Additionally, the second clutch assembly 54 can be actuated proportionally, along with the inertia brake housing 40 to control the speed of the input shaft 20. Coupling of the input shaft 20 to the inertia brake housing 40 brakes the input shaft 20. The amount that the input shaft 20 is braked is proportionally controlled and synchronized with rotation of the flywheel 18 to prevent tooth butt during gear changes.

Another function of the inertia brake assembly 12 is to drive the power take-off assembly 24. The auxiliary gear 66 that is driven by the inertia brake housing 40 rotates the power take-off assembly 24. Any time the inertia brake housing 40 is rotating the auxiliary gear 66 rotates. The auxiliary gear 66 drives the rotating housing 74. Selective actuation of the power take-off clutch assembly 68 couples the rotating housing 74 with the power take-off shaft 70. The power take-off assembly 24 is thereby actuated to drive an auxiliary device.

The power take-off assembly 24 can be driven by transmitting torque through the input shaft 20 to the inertia brake housing 40 or through the hollow shaft 26 to the inertia brake housing 40. Each coupling arrangement provides individual advantages. Driving the inertia brake housing 40 through the hollow shaft 26 provides for the operation of the power take-off assembly 24 separate from driving of the transmission 10. This allows the power take-off assembly 24 to be used when the vehicle is stationary thereby eliminating the need to couple the input shaft 20 to the flywheel 18. Transmission of torque through the hollow shaft 26, bypasses the master clutch assembly 16, thereby reducing the amount of wear caused by driving the power take-off assembly 24.

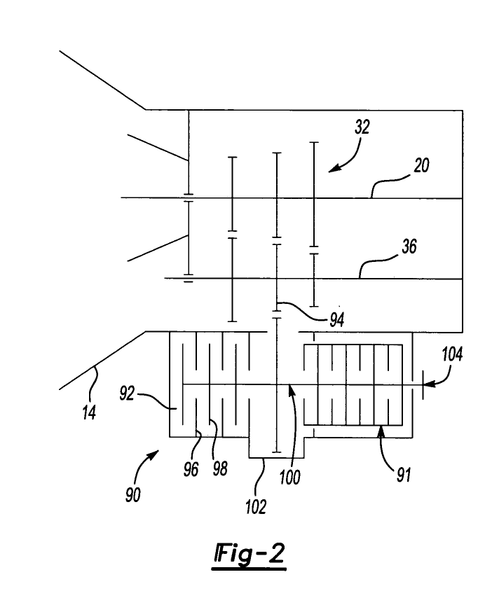

Referring to FIG. 2, another power take off assembly 90 according to this invention is shown and includes a grounded clutch assembly 92 and a power take off clutch assembly 91. The power take off assembly 90 is driven from a gear 94 rotating with the countershaft 36. Alternatively, an inertia brake housing 40 as disclosed in FIG. 1 with can drive the power take off assembly 90 through the auxiliary gear 66.

The grounded clutch assembly 92 provides the function of a hill-holding device. The grounded clutch assembly 92 includes a plurality of pressure plates 96 that are fixed to housing 102 to prevent rotation. The pressure plates 96 can move axially to engage a corresponding plurality of friction plates 98. The grounded clutch assembly 92 grounds an auxiliary shaft 100 to the housing 102. The power take-off clutch assembly 91 couples a power take-off shaft 104 to the auxiliary shaft 100 to drive an auxiliary device.

The result of engaging the grounded clutch assembly 92 is that the countershaft 36, and thereby the input shaft 20 are grounded. Grounding of the input shaft 20 through the countershaft 36, and power take-off assembly 90 provides for holding of the vehicle during start up on an incline. With the grounded clutch assembly 92 open, the auxiliary shaft 100 rotates. Actuation of the power take-off clutch assembly 91 couples the auxiliary shaft 100 to the take-off shaft 104 to drive an auxiliary device. Further, the grounded clutch assembly 92 can be proportionally actuated to control the rotational speed of the power take-off shaft 104.

The inertia brake assembly 12 of this invention provides first and second clutch assemblies 48,54 that are selectively coupled to provide several functions in a single compact durable and highly adaptable device. The inertia brake assembly 12 is actuated to couple the input shaft 20 and flywheel to various components, or to a fixed housing to control rotation, and provide for braking of the vehicle during initial start up on an incline.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. A transmission assembly comprising:
a fixed housing;
an input shaft rotatable about an axis;
a hollow shaft rotatable relative to said input shaft;
an inertia brake housing rotatable relative to said input shaft and said hollow shaft;
a first clutch assembly for coupling said hollow shaft to said inertia brake housing;
a second clutch assembly for coupling said input shaft to said inertia brake housing; and
a retarder assembly for coupling said inertia brake housing to said fixed housing.

2. The assembly as recited in claim 1, wherein said inertia brake housing is partially received within said hollow shaft.

3. The assembly as recited in claim 2, wherein said first clutch assembly is disposed within an annular space between said hollow shaft and said inertia brake housing.

4. The assembly as recited in claim 1, wherein said second clutch assembly is disposed within an annular space between said input shaft and said inertia brake housing.

5. The assembly as recited in claim 1, wherein said input shaft, said hollow shaft and said inertia brake housing are rotatable about said axis.

6. The assembly as recited in claim 1, comprising a master clutch assembly for coupling said input shaft to a driven member.

7. The assembly as recited in claim 6, wherein said hollow shaft is fixed to rotate with said driven member.

8. The assembly as recited in claim 7, wherein said hollow shaft rotates with said driven member independent of said input shaft.

9. The assembly as recited in claim 1, wherein a portion of said retarder assembly is mounted to said inertia brake housing and another corresponding portion of said retarder assembly is mounted to said fixed housing.

10. The assembly as recited in claim 1, wherein said first clutch assembly comprises a plurality of pressure plates mounted to an inner surface of said hollow shaft and is engageable with a corresponding plurality of friction plates mounted on an outer surface of said inertia brake housing.

11. The assembly as recited in claim 1, wherein said second clutch assembly comprises a plurality of pressure plates mounted to an inner surface of said inertia brake housing and a corresponding plurality of friction plates mounted to an outer surface of said input shaft.

12. The assembly as recited in claim 1, comprising a power take-off assembly driven by said inertia brake housing.

13. The assembly as recited in claim 12, comprising an auxiliary gear driven by said inertia brake housing for driving said power take-off assembly.

14. The assembly as recited in claim 13, wherein said power take-off assembly comprises an auxiliary shaft driven by said auxiliary gear, a power take-off shaft, and a power take-off clutch assembly for coupling said auxiliary shaft to said power take-off shaft.

15. The assembly as recited in claim 14, wherein said power take-off assembly comprises a grounded clutch assembly for coupling said auxiliary shaft to said fixed housing to control rotational speed of said auxiliary shaft.

16. The assembly as recited in claim 15, wherein said grounded clutch assembly comprises a plurality of pressure plates fixed to prevent rotation relative to said fixed housing and a corresponding plurality of friction plates fixed to said auxiliary shaft.

17. A transmission assembly comprising:
a fixed housing;
a driven member;
an auxiliary shaft driven by said driven member;
a power take-off clutch for coupling said auxiliary shaft to said driven member; and
a grounded clutch assembly for coupling said driven member to said fixed housing for controlling rotational speed of said driven member.

18. The assembly as recited in claim 17, wherein said driven member comprises a countershaft.

19. The assembly as recited in claim 17, wherein said driven member comprises an inertia brake housing.

20. The assembly as recited in claim 17, wherein said grounded clutch assembly comprises a plurality of pressure plates and a corresponding plurality of friction plates, wherein one of said plurality of pressure plates and said friction plates is fixed to a support housing such that engagement retards rotation of said driven member.

21. A brake assembly for a transmission comprising:
a hollow shaft rotatable relative to an input shaft of the transmission;
an inertia brake housing rotatable relative to said input shaft and said hollow shaft;
a first clutch assembly for coupling said hollow shaft to said inertia brake housing;
a second clutch assembly for coupling said input shaft to said inertia brake housing; and
a retarder assembly for coupling said inertia brake housing to said fixed housing.

22. The assembly as recited in claim 21, wherein said inertia brake housing is partially received within said hollow shaft.

23. The assembly as recited in claim 22, wherein said first clutch assembly is disposed within an annular space between said hollow shaft and said inertia brake housing.

24. The assembly as recited in claim 21, wherein said second clutch assembly is disposed within an annular space between said input shaft and said inertia brake housing.

25. The assembly as recited in claim 21, wherein said input shaft, said hollow shaft and said inertia brake housing are rotatable about an axis.

26. The assembly as recited in claim 21, wherein a portion of said retarder assembly is mounted to said inertia brake housing and another corresponding portion of said retarder assembly is mounted to said fixed housing.

27. The assembly as recited in claim 21, comprising an auxiliary gear driven by said inertia brake housing for driving a power take-off assembly.
